(19) United States
(12) Patent Application Publication
(10) Pub. No.: US 2026/0035103 A1
(43) Pub. Date: Feb. 5, 2026

(54) MACHINE LEARNING BASED MANY-OBJECTIVE OPTIMIZATION FOR AIRCRAFT PARTS MACHINING

(71) Applicant: THE BOEING COMPANY, Arlington, VA (US)

(72) Inventors: Kishora SHETTY, Bengaluru (IN); Pranav S. SHETTY, Mangalore (IN); Pranjal PATHAK, Bengaluru (IN); Nayan MAITI, Bangalore (IN)

(21) Appl. No.: 18/793,619

(22) Filed: Aug. 2, 2024

(51) Int. Cl. B64F 5/10; G05B 19/4063

(52) U.S. Cl. CPC B64F 5/10; G05B 19/4063; G05B 2219/31336; G05B 2219/32091; G05B 2219/33099; G05B 2219/45071

(57) ABSTRACT

The present disclosure provides techniques for improving aircraft machining process using machine learning-based predictive models and many-objective optimization algorithms. Data from a machining process is collected, where the data comprises a plurality of machining parameters and at least two performance metrics. For each respective performance metric, a respective predictive model is trained using one or more machine learning (ML) techniques, where the plurality of machining parameters are used as inputs, the respective performance metric as target outputs, and the respective predictive model learns to correlate the inputs to the target output. For each respective performance metric, a respective objective function is generated for the respective predictive model. Many-objective optimization is performed on the respective objective functions, and a set of solutions are generated for the machining process based on the many-objective optimization.

### FIELD

Aspects of the present disclosure relate to aircraft parts machining, and more specifically, to using machine learning-based many-objective optimization techniques to enhance the performance of aircraft parts production.

### BACKGROUND

Precision computer numerical control (CNC) is an important aspect of the aerospace industry, which demands high production standards and stringent safety and quality controls due to the high risk involved in aerospace operations. A single defective or imperfect component may result in catastrophic safety risks and potentially endanger human lives. Therefore, the manufacturing of aircraft parts generally requires the tightest dimensional tolerance and precise controls to ensure these parts function correctly during flight. On the other hand, the aerospace industry often involves multiple production lines, which adds additional complexity to the manufacturing process. Multiple production lines may lead to extensive cross-production, which makes it more challenging to maintain efficiency and consistency during manufacturing due to the reduced specialization and integration.

### SUMMARY

The present disclosure provides a method in one aspect, including collecting data from a machining process, where the data comprises a plurality of machining parameters and at least two performance metrics, for each respective performance metric, training a respective predictive model using one or more machine learning (ML) techniques and generating an objective function for the predictive model, where the plurality of machining parameters are used as inputs, the respective performance metric is used as a target output, and the respective predictive model learns to correlate the inputs to the target output, generating a respective objective function for the respective predictive model, performing many-objective optimization on the respective objective functions, and generating a set of solutions for the machining process based on the many-objective optimization.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing one or more programs that, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIGS. 1A and 1B depict an example workflow for aircraft part machining optimization, according to some aspects of the present disclosure.

FIG. 2 depicts an example performance chart with pareto optimal solutions for minimizing cutting time and maximizing tool life, according to some aspects of the present disclosure.

FIG. 3 depicts an example performance chart with refined pareto optimal solutions for minimizing cutting time and maximizing tool life, according to some aspects of the present disclosure.

FIG. 4 depicts an example method for collecting data for machining optimization, according to some aspects of the present disclosure.

FIG. 5 depicts an example method for training ML models using collected data and developing objective functions for optimization, according to some aspects of the present disclosure.

FIG. 6 depicts an example method for generating and refining pareto optimal solutions using many-objective optimization algorithms, according to some aspects of the present disclosure.

FIG. 7 is a flow diagram depicting an example method for machine learning-based many-objective optimization, according to some aspects of the present disclosure.

FIG. 8 depicts an example computing device configured to perform various aspects of the present disclosure, according to some aspects of the present disclosure.

### DETAILED DESCRIPTION

The present disclosure introduces mechanisms for enhanced machining of aircraft parts using computer numerical control (CNC) cutting machines. In selecting and setting up CNC cutting machines, a number of objectives may be considered, primarily focusing on the cost, time, quality, and environmental impacts of the machining process. Reducing cutting time, optimizing total tool life, achieving high-quality finish, and lowering power consumption are a few examples of possible objectives. Optimizing machining parameters like cutting speed, feed rate, and depth of cut for one objective may adversely affect another. The present disclosure provide techniques for evaluating the tradeoffs between multiple objectives, and identifying combinations of machining parameters that balance the manufacturing performance across the considered objectives.

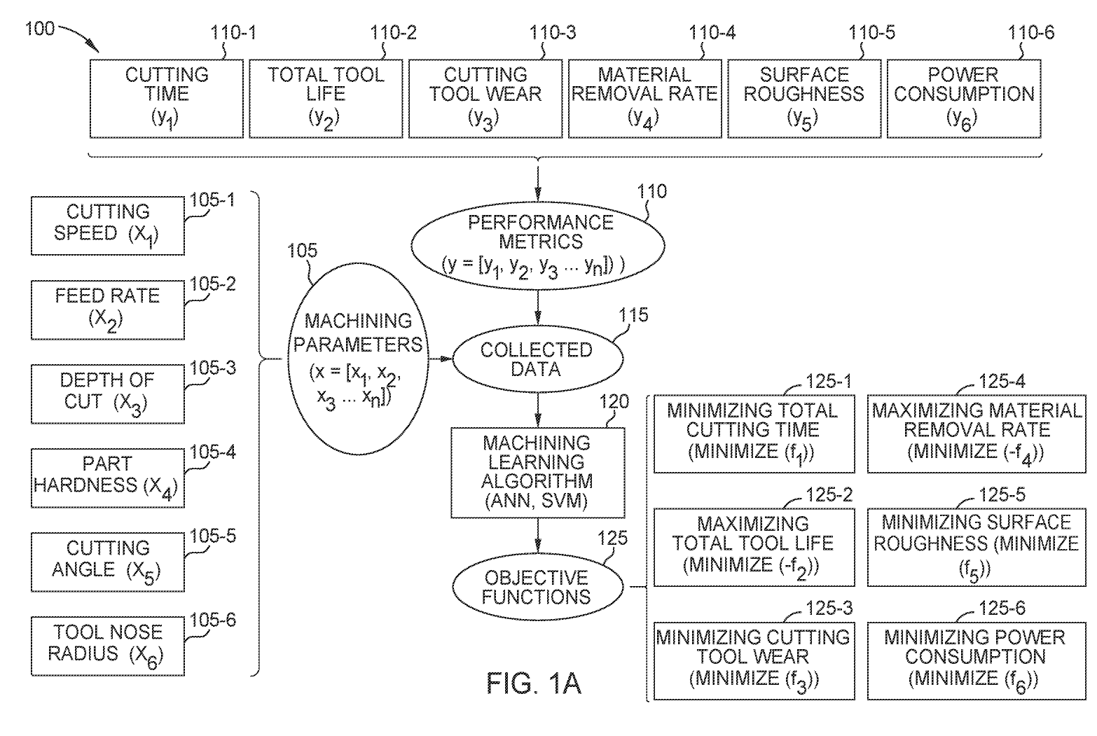

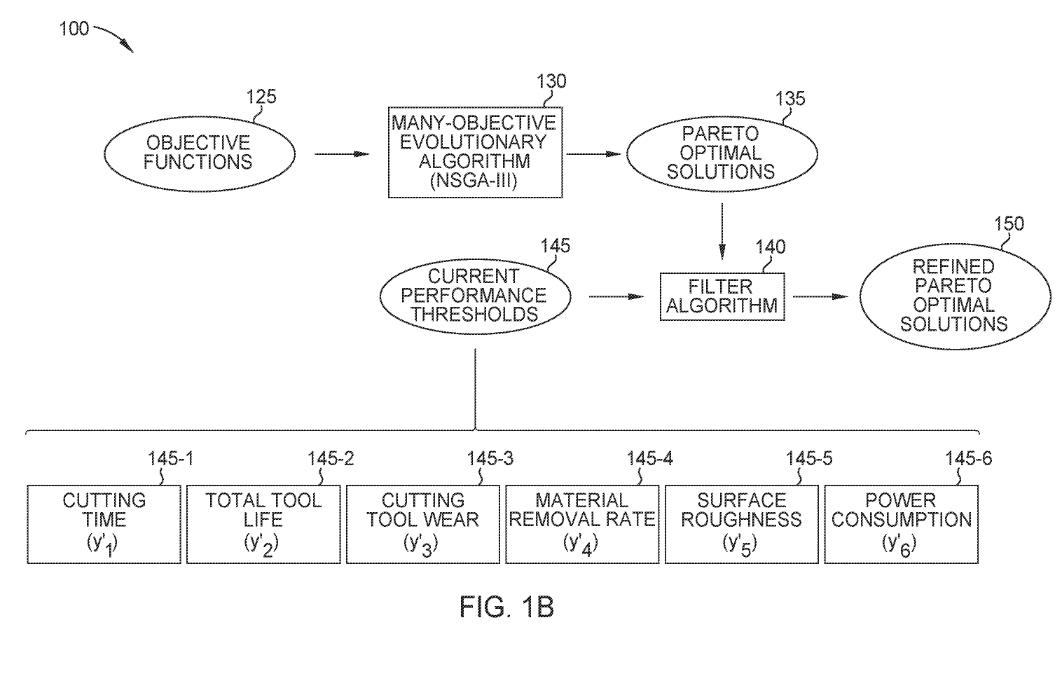

FIGS. 1A and 1B depict an example workflow 100 for aircraft part machining optimization, according to some aspects of the present disclosure.

The workflow 100 begins with the selection of the appropriate machining parameter (x) 105 and performance metrics (y) 110. As used herein, machining parameters (x) 105 refer to the variables that can be controlled or adjusted before and/or during the CNC machining process to affect the quality, speed, cost, and/or environmental sustainability of production. These parameters may be used for adjusting the machining process to specific material properties and desired outcomes. As illustrated, the machining parameters include cutting speed (x₁) 105-1, feed rate (x₂) 105-2, depth of cut (x₃) 105-3, part hardness (x₄) 105-4, cutting angle (x₅) 105-5, and tool nose radius (x₆) 105-6.

In some aspects, the cutting speed (x₁) 105-1 may refer to the speed at which the cutting tool moves relative to the material being cut. The cutting speed may be measured in feet per minute (FPM) or meters per minute (MPM). In some aspects, the feed rate (x₂) 105-2 may refer to the rate at which the workpiece is fed into the cutting tool. In some aspects, the depth of cut (x₃) 105-3 may refer to the depth of the cutter into the workpiece, which may affect the material removal rate and/or tool wear of the cutter. In some aspects, the part hardness (x₄) 105-4 may refer to the hardness of the material being machined. In some aspects, the part hardness (x₄) 105-4 may affect the cutting speed and feed rate of the machine, as harder materials may require slower speeds or lighter cuts to avoid excessive tool wear. In some aspects, the cutting angle (x₅) 105-5 may refer to the angle at which the tool is positioned relative to the workpiece. In some aspects, the cutting angle (x₅) 105-5 may affect how the cutting forces are distributed. In some aspects, the tool nose radius (x₆) 105-6 may refer to the radius of the tip of the cutting tool. In some aspects, larger tool nose radius may improve finish quality and strength, but may also increase cutting forces.

As used herein, performance metrics (y) 110 refer to the variables that can be used to evaluate the efficiency and/or quality of the machining process. As illustrated, the performance metrics include cutting time (y₁) 110-1, total tool life (y₂) 110-2, cutting tool wear (y₃) 110-3, material removal rate (y₄) 110-4, surface roughness (y₅) 110-5, and power consumption (y₆) 110-6. In some aspects, the cutting time (y₁) 110-1 may refer to the total time required to complete the machining operation. Minimizing cutting time may increase throughput and reduce operational costs. In some aspects, total tool life (y₂) 110-2 may refer to the duration that a cutting tool is effective before it needs replacement. By maximizing the total tool life, tool costs and machine downtime for tool changes may be effectively reduced. In some aspects, the cutting tool wear (y₃) 110-3 may refer to the rate at which the cutting tool experiences wears during the machining process. Minimizing the cutting tool wear may reduce tool costs and/or machine downtime. In some aspects, the material removal rate (y₄) may refer to the volume of material removed per unit of time during machining. The material removal rate may be increased to increase throughput, and/or reduce energy consumption (per unit of material removed). In some aspects, the surface roughness (y₅) 110-5 may measure the surface quality of the machined part. Low surface roughness may indicate high machining quality. In some aspects, the power consumption (y₆) 110-6 may refer to the amount of energy consumed by the machining process. Lowering power consumption may reduce operational costs and/or be better for environmental sustainability.

The depicted machining parameters (x) and performance metrics (y) are provided for conceptual clarity. In some aspects, other machining parameters and performance metrics may be used, depending on specific operational objectives and machine capabilities.

Depending on the operational objectives of a machining process, one or more performance metrics (y) 110 may be selected for optimization. In a many-objective optimization setting, at least two performance metrics may be selected to ensure a balanced approach for improving multiple aspects of machining operations simultaneously. Based on the capabilities of the CNC cutting machine and the material properties, the optimization system may choose one or more machining parameters (x) 105 that potentially influence the selected performance metrics. For example, if the operational goals are to enhance productivity and extend tool life, the cutting time (y₁) 110-1 and total tool life (y₂) 110-2 may be selected. Since these two performance metrics depend significantly on operational efficiency and wear rates, machining parameters like cutting speed (x₁) 105-1, feed rate (x₂) 105-2, and depth of cut (x₃) 105-3 may be selected.

After selecting the appropriate machining parameters (x) 105 and performance metrics (y) 110, the optimization system may then collect data related to these parameters. The data collection may include capturing the interactions between the selected machining parameters (x) 105 and the resulting outcomes for the selected performance metrics (y) 110. In the above example, the data collection may involve measuring how adjustments in cutting speed (x₁) 105-1, feed rate (x₂) 105-2, and depth of cut (x₃) 105-3 impact the cutting time (y₁) 110-1 and total tool life (y₂) 110-2. The unselected machining parameters, such as part hardness (x₄) 105-4, cutting angle (x₅) 105-5, and tool nose radius (x₆) 105-6, may remain unchanged during the data collection process. This approach ensures that variations in the measured performance metrics (e.g., cutting time (y₁) and tool life (y₂)) may be directly attributed to changes in the selected machining parameters (e.g., cutting speed (x₁), feed rate (x₂), and depth of cut (x₃)).

The collected data 115 is then provided to machine learning algorithms 120 for model training. In the above example, the collected data 115 may be represented as follows:

Inputs: X = [x₁, x₂, x₃]

Outputs: Y = [y₁, y₂]

The models are trained to predict the selected performance metrics (e.g., cutting time (y₁) and tool life (y₂)) based on the selected machining parameters (e.g., cutting speed (x₁), feed rate (x₂), and depth of cut (x₃)). In the above example, two models may be trained, one predicting cutting time (y₁) based on inputs like cutting speed (x₁), feed rate (x₂), and depth of cut (x₃), and the other one predicting tool life (y₂) based on inputs like cutting speed (x₁), feed rate (x₂), and depth of cut (x₃).

Various machine learning algorithms 120 may be selected, including, but not limited to, linear regression, random forest regression, support vector machines (SVMs), and artificial neural networks (ANNs). In some aspects, during the training process, the selected machining parameters (e.g., cutting speed (x₁), feed rate (x₂), and depth of cut (x₃)) may be used as input features, and the performance metrics (e.g., cutting time (y₁) and tool life (y₂)) may be used as target outputs. The selected ML algorithm 120 may learn to correlate these input features to the target outputs, and adjust its internal parameters to minimize the error between the predicted outputs (y^) and the target outputs (y). The trained model may be represented as follows:

y^ = f (x₁, x₂, x₃, . . . , xₙ), where y^ is the predicted value of a performance metric, and fis the predictive model for the performance metric.

In the above example, the trained models may be represented as follows:

y₁^ = f₁(x₁, x₂, x₃), where y₁^ is the predicted value of cutting time, and f₁is the predictive model for cutting time; and

y₂^ = f₂(x₁, x₂, x₃), where y₂^ is the predicted value of total tool life, and f₂ is the predictive model for total tool life.

In some aspects, the collected data 115 may be divided into three datasets, including the training dataset, validation dataset, and testing dataset. In some aspects, the training dataset may be used to train the ML model, where the model learns the relationship between inputs and outputs. In some aspects, the validation dataset may test the model’s predictions against known outputs to evaluate the model’s accuracy. Based on the accuracy, the model’s internal parameters (e.g., weights in an ANN) may be fine-tuned to avoid overfitting on the training dataset. In some aspects, the testing dataset may include a set of data not seen during training and validation, and be used to provide an unbiased evaluation of the model’s performance.

After the machine learning models are trained and validated, objective functions 125 are developed based on the predictive models. Each objective function may represent an optimization goal (e.g., minimizing cutting time, maximizing total tool life, minimizing cutting tool wear, maximizing material removal rate, minimizing surface roughness, minimizing power consumption) based on a respective predicted performance metric (e.g., cutting time (y₁), tool life (y₂), cutting tool wear (y₃), material removal rate (y₄), surface roughness (y₅), and power consumption (y₆)). For example, the objective function 125-1 for minimizing the cutting time may be represented as follows:

minimize (y₁^) = minimize (f₁ (x₁, x₂, x₃, . . . , xₙ)), where y₁^ is the predicted value of cutting time, and f₁is the predictive model for cutting time.

To maximize the tool life, the corresponding objective function 125-2 may be structured to minimize the negative of the predicted tool life, represented as follows:

minimize (-y₂^) = minimize (-f₂(x₁, x₂, x₃, . . . , xₙ)), where y₂^ is the predicted value of cutting time, and f₂is the predictive model for total tool life.

The objective function 125-3 for minimizing the cutting tool wear may be represented as follows:

minimize (y₃^) = minimize (f₃ (x₁, x₂, x₃, . . . , xₙ)), where y₃^ is the predicted value of cutting tool wear, and f₃ is the predictive model for cutting tool wear.

Maximizing the material removal rate is typically desired to improve productivity. To maximize the material removal rate, the corresponding objective function 125-4 may be structured to minimize the negative of the predicted material removal rate, represented as follows:

minimize (-y₄^) = minimize (-f₄ (x₁, x₂, x₃, . . . , xₙ)), where y₄^ is the predicted value of material removal rate, and f₄ is the predictive model for material removal rate.

Surface roughness affects the aesthetic and functional aspects of a matching part. A lower surface roughness may indicate a smoother finish. To minimize the surface roughness, the corresponding objective function 125-5 may be represented as follows:

minimize (y₅^) = minimize (f₅ (x₁, x₂, x₃, . . . , xₙ)), where y₅^ is the predicted value of surface roughness, and f₅ is the predictive model for surface roughness.

Minimizing the power consumption may reduce operational costs and improve environmental sustainability. To minimize the power consumption, the corresponding objective function 125-6 may be represented as follows:

minimize (y₆^) = minimize (f₆ (x₁, x₂, x₃, . . . , xₙ)), where y₆^ is the predicted value of power consumption, and f₆ is the predictive model for power consumption.

In the above example, if machining parameters like cutting speed (x₁), feed rate (x₂), and depth of cut (x₃)) are selected, the objective functions are adjusted to use these parameters for optimal outcomes. The objective functions 125-1 for minimizing cutting time may be represented as minimize (y₁^) = minimize (f₁(x₁, x₂, x₃)), and the objective functions 125-2 for maximizing total tool life may be represented as minimize (-y₂^) = minimize (-f₂(x₁, x₂, x₃)).

The six objective functions 125 as depicted in FIG. 1A are provided for conceptual clarity, to illustrate how different operational goals may be achieved by controlling specific machining parameters. In some aspects, additional performance metrics may be considered based on specific machining requirements, and corresponding predictive models and objective functions may be generated to address these additional metrics.

Turning now to FIG. 1B, as illustrated, the generated objective functions 125 are provided to the many-objective evolutionary algorithms 130 for further processing. In some aspects, the many-objective evolutionary algorithms 130 may be designed to handle complex optimization issues involving multiple conflicting objectives. Examples of such algorithms may include non-dominated sorting generic algorithm III (NSGA-III) and multi-objective evolutionary algorithm based on decomposition (MOEA/D). The optimization algorithms 130 process the objective functions 125 to identify a set of pareto optimal solutions 135. Each pareto optimal solution may include a unique set of values for the machining parameters (x), and represent a different tradeoff between the considered objectives in the machining process.

Each pareto optimal solution may be represented as p* = [x₁*, x₂*, x₃*, . . . , xₙ*], where x₁*, x₂*, . . . , xₙ* are specific values of the machining parameters that define the solution. Each solution has associated predicted values for performance metrics, determined based on the predictive models. For example, the predictive cutting time y₁* may be represented as follows:

y₁* = f₁ (x₁*, x₂*, x₃*, . . . , xₙ*)

The predictive total tool life y₂* may be represented as follows:

y₂* = f₂ (x₁*, x₂*, x₃*, . . . , xₙ*)

In the above example, where objective functions for minimizing cutting time and maximizing total tool life are generated, each pareto optimal solution identified by the optimization algorithms 130 may include a set of values for cutting speed (x₁), feed rate (x₂), and depth of cut (x₃), represented as p* = [x₁*, x₂*, x₃*]. Each solution has an associated predicted cutting time, represented as y₁* = f₁ (x₁*, x₂*, x₃*), and an associated total tool life, represented as y₂* = f₁ (x₁*, x₂*, x₃*). Each pareto represents a balance between the objectives of minimizing cutting time and maximizing tool life. For example, one solution may slightly increase the cutting time to achieve a significantly longer tool life, while another solution may minimize the cutting time but result in a shorter tool life.

As illustrated, both the generated set of pareto optimal solutions 135 and the current performance thresholds 145 are provided to the filter algorithm 140. The filter algorithm 140 is configured to apply the current performance thresholds 145 to further refine the pareto optimal solutions. In some aspects, the current performance threshold 145 may be determined by measuring real-time machining parameters (x’) during operations, such as cutting speed (x₁’), feed rate (x₂’), depth of cut (x₃’), part hardness (x₄’), cutting angle (x₅’), and tool nose radius (x₆’). These real-time parameters may then be fed into the previously developed predictive models to generate corresponding performance metrics (y’), such as cutting time (y₁’) 145-1, total tool life (y₂’) 145-2, cutting tool wear (y₃’) 145-3, material removal rate (y₄’) 145-4, surface roughness (y₅’) 145-5, and power consumption (y₆’) 145-6. These predicted performance metrics (y’) may be set as the current performance thresholds 145, representing the baseline performance levels of the CNC cutting machine.

The filter algorithm 140 receives the performance thresholds (y’) 145 and the pareto optimal solutions 135 from the optimization algorithm. Each pareto solution includes predicted performance metrics (y*), determined from the optimized machining parameters (x*). The filter algorithm 140 then compares the current performance thresholds (y’) 145 with each pareto solution’s corresponding predicted metrics (y*).

In the above example where objective functions for minimizing cutting time and maximizing total tool life are generated, the pareto optimal solutions identified by the optimization algorithms 130 may each include a set of values for cutting speed (x₁), feed rate (x₂), and depth of cut (x₃), and represent a balance between the objectives of minimizing cutting time and maximizing tool life. For example, one solution may slightly increase the cutting time to achieve a significantly longer tool life, while another solution may minimize cutting time but result in a shorter tool life.

In the above example, where objective functions for minimizing cutting time and maximizing total tool life are generated, the filter algorithm 140 may exclude any pareto where the predicted cutting time (y₁*) is longer than the threshold cutting time (y₁’) 145-1, and/or the predicted tool life (y₂*) is less than the threshold tool life (y₂’) 145-1.

The set of pareto optimal solutions 135 may be represented as {p₁*, p₂*, p₃*, , . . . , pₖ*}. The set of refined pareto optimal solution 150 may be represented as {p₁*, p₂*, p₃*, . . . , pⱼ*} (where j ≤ k).

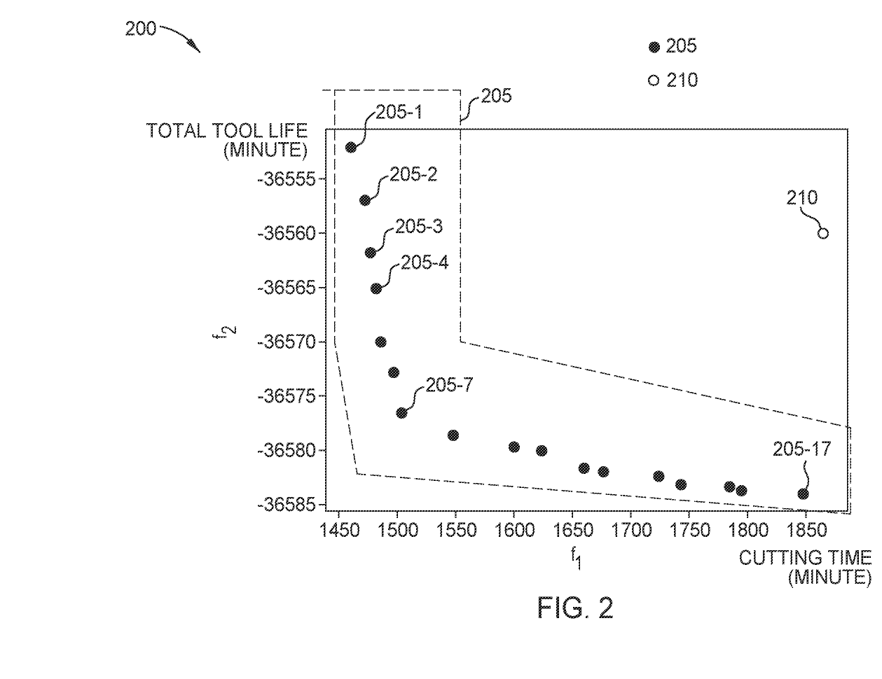

FIG. 2 depicts an example performance chart 200 with pareto optimal solutions for minimizing cutting time and maximizing tool life, according to some aspects of the present disclosure.

As illustrated, the blue points 205 represent the set of pareto optimal solutions identified from a many-objective optimization algorithm. These solutions are plotted within a two-dimensional (2D) framework, where the horizontal axis (x-axis) represents cutting time in minutes, and the vertical axis (y-axis) represents the negative total tool life in minutes. Each solution has a unique combination of machining parameters (e.g., cutting speed (x₁’), feed rate (x₂’), and depth of cut (x₃’)) that balance the tradeoffs between the objective of minimizing cutting time and the objective of maximizing tool life. The positioning of the blue points 205 closer to the origin (e.g., 205-7) indicates better overall performance, as these locations correspond to shorter cutting time and longer tool lives.

In addition to the blue points, a black point 210 is included to represent the CNC machine’s current operational status. The point’s location corresponds to the cutting time (y₁’) and total tool life (y₂’) as predicted or estimated based on the current values of machining parameters (e.g., cutting speed (x₁’), feed rate (x₂’), and depth of cut (x₃’)). The black point serves as a baseline, allowing for a direct visual comparison between the current machine settings and potential improvements offered by the pareto optimal solutions.

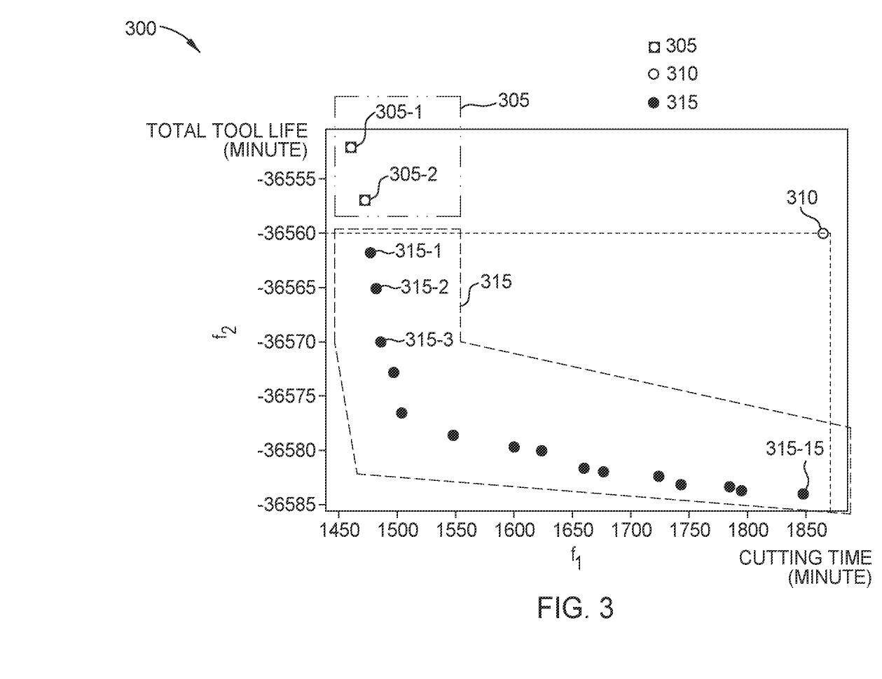

In some aspects, the black point 210 may separate the blue points 205 into two categories (e.g., red points and green points) based on their performance relative to the current settings. More detail is discussed below with reference to FIG. 3.

FIG. 3 depicts an example performance chart 300 with refined pareto optimal solutions for minimizing cutting time and maximizing tool life, according to some aspects of the present disclosure. The black point 310 may correspond to the black point 210 as depicted in FIG. 2, representing the current operational status of the CNC machine. Specifically, the black point 310 has a cutting time of 1850 minutes and a negative total tool life of (-36560) minutes. The black point 310 sets up the baseline for assessing the performance of the set of pareto optimal solutions identified by the NSGA-III algorithm (e.g., the blue points 205 in FIG. 2).

As depicted, the set of pareto optimal solutions is categorized into two groups: red points 305 and green points 315. The red points 305 represent solutions that do not offer improvements over the current operational settings, indicated by either longer cutting time or shorter tool lives (or both) than those currently achieved. For example, the red point 305-1 is shown with a negative total tool life of (-36553) minutes, which is higher than the threshold of (-36560) minutes, suggesting a shorter tool life. The red point 350-2 has a negative total tool life of (-36557) minutes, which is higher than the threshold of (-36560) minutes and therefore indicates a shorter tool life. In some aspects, the shorter tool lives may lead to increased maintenance costs and/or decreased production efficiency. Therefore, the solutions represented by red points 305 should be excluded from consideration for optimizing the machining process.

The green points 315 represent solutions that provide improvements over the current operational settings, through shorter cutting times, improved tool lives, or both. For example, the green point 315-1 is shown with a negative total tool life of (-36562) minutes, which is lower (better) than the current tool life threshold of (-36560) minutes, and a cutting time of 1475 minutes, which is shorter (better) than the current cutting time threshold of 1875 minutes. In some aspects, shorter tool lives and/or improved tool lives may contribute to enhanced productivity and/or reduced maintenance costs. Therefore, the solutions represented by the green points 315 should be selected as a refined set of pareto optimal solutions (e.g., 150 of FIG. 1B).

In some aspects, to optimize the machining process, engineers and operational managers may select a solution from the refined set of pareto optimal solutions (represented by the green points 315) that best fits their specific operational constraints and priorities. The decision-making process may involve evaluating each solution’s tradeoffs and benefits to determine the most suitable option for current production requirements. For high-volume production where cutting speed is more important than the cost of tool replacement, green point 315-1 may be selected, which represent a solutions where cutting time is significantly minimized at the cost of shorter tool life. However, the tradeoff may be justified because the slightly reduced tool life of (-36562) minutes) is still lower (better) than the current tool life threshold of (-36560) minutes, representing an improvement over the current machine’s performance.

In high-precision industry where equipment wear may affect product quality, tool cost or tool change downtime may be given more weight than production speed. In such configurations, green point 315-15 may be selected, which represents a solution where tool life is significantly extended at the cost of an increase in cutting time. However, the increased cutting time of 1850 minutes is still an improvement over the current machine setting with a cutting time of 1875 minutes. Therefore, green point 315-15 is a viable option for maintaining high quality and reducing long-term operational costs.

The example performance charts 200 and 300 in FIGS. 2 and 3 show the application of many-objective evolutionary optimization to two objective functions, with pareto optimal solutions plotted within a 2D framework. The example performance charts are provided for conceptual clarity. In some aspects, the optimization process may involve more than two objectives. For example, when three objective functions are optimized simultaneously, such as adding the minimization of power consumption (f₆) to the existing objectives of cutting time and tool life, the generated pareto solutions may be mapped to a 3D framework. For situations involving four or more objectives, conventional 2D or 3D plots become inadequate. In some aspects, visualization techniques such as parallel coordinate plots or radar charts may be used to display multiple dimensions simultaneously, with each axis representing a different objective and points representing individual solutions.

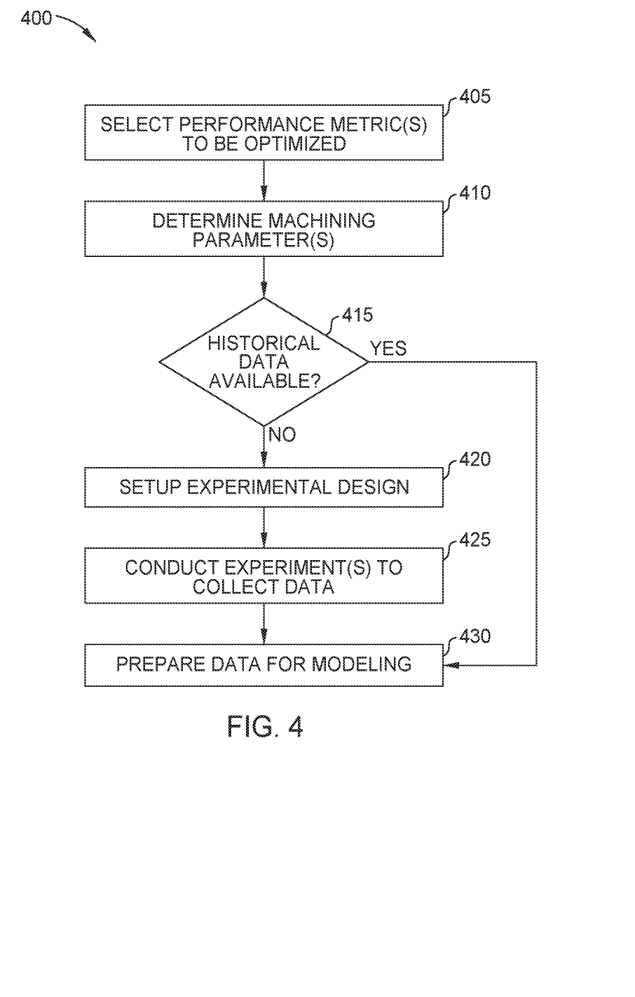

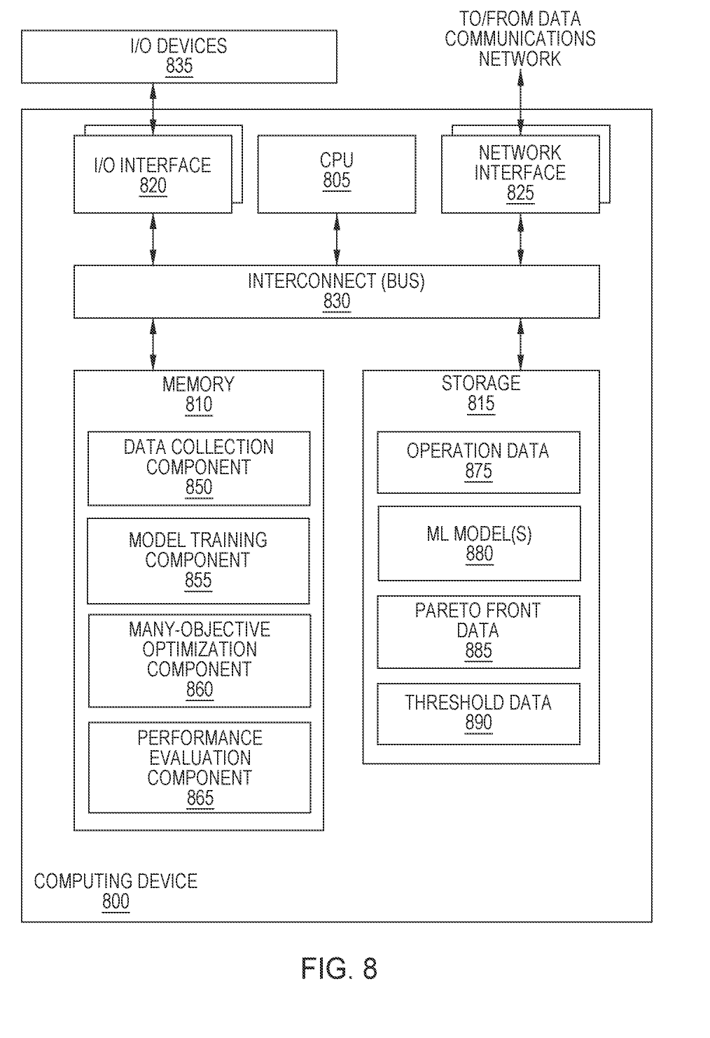

FIG. 4 depicts an example method 400 for collecting data for machining optimization, according to some aspects of the present disclosure. In some aspects, the method 400 may be performed by one or more computing devices, such as the computing device 800 as depicted in FIG. 8.

At block 405, a computing device is programmed by engineers to identify one or more performance metrics that need optimization. The selection of metrics may depends on various factors, including, but not limited to, the specific goals of the production process (e.g., reducing production time, lowering costs, or minimizing environmental impact), the nature of the products being machined (e.g., the type of materials used, the complexity of part geometrics, and the precision required in the finished products), and the CNC machine’s capabilities. In some aspects, the performance metrics used to evaluate the machining process may primarily focus on the cost, quality, time, and environment impacts. The performance metrics may include, but are not limited to, cutting time (110-1 of FIG. 1A), total tool life (e.g., 110-2 of FIG. 1A), cutting tool wear (e.g., 110-3 of FIG. 1A), material removal rate (e.g., 110-4 of FIG. 1A), surface roughness (e.g., 110-5 of FIG. 1A), and power consumption (e.g., 110-6 of FIG. 1A). By selecting appropriate performance metrics, the subsequent optimization efforts for adjusting the machining parameters (e.g., cutting speed, feed rate, depth of cut) may be ensured to be aligned with operational objectives. In the context of many-objective optimization, at least two performance metrics may be selected. This approach ensures that the many-objective optimization algorithm (NSGA-III) may evaluate tradeoffs between different operational goals, and generate optimization solutions that address multiple aspects of CNC machining performance simultaneously.

After identifying the performance metrics, at block 410, the computing device determines the specific machining parameters that need to be varied and measured to optimize these metrics. In some aspects, each selected performance metric may be analyzed to understand which machining parameters most likely impact its outcome. The analysis may involve a combination of historical data review and/or expert knowledge of CNC machining process. In some aspects, the machining parameters may include, but are not limited to, cutting speed (e.g., 105-1 of FIG. 1A), feed rate (e.g., 105-2 of FIG. 1A), depth of cut (e.g., 105-3 of FIG. 1A), part hardness (e.g., 105-4 of FIG. 1A), cutting angle (e.g., 105-5 of FIG. 1A), and tool nose radius (e.g., 105-6 of FIG. 1A).

At block 415, the computing device checks the availability of historical data relevant to the selected machining parameters and performance metrics. In some aspects, the assessment may include analyzing whether the historical data sufficiently covers the ranges and combinations of machining parameters selected to validate the performance metrics. Also, in some aspects, the computing device may further evaluate the consistency of unselected machining parameters within the historical data to ensure they do not compromise the future analysis and modeling. If adequate historical data is available and considered reliable, the method 400 proceeds directly to block 430, where data is prepared for modeling and optimization. If historical data is lacking or considered unreliable (e.g., the historical data is incomplete or outdated, or unselected machining parameters within the historical data have inconsistent values), the method 400 proceeds to block 420.

At block 420, the computing device sets up a series of experiments or data collection runs to vary the selected machining parameters (also referred to in some aspects as input parameters). In some aspects, design of experiments (DoE) techniques may be used to vary the input parameters. In some aspects, for setting up the experiments, proper cutting centers and cutting tools may be selected based on the materials and conditions defined for the experiments. The unselected machining parameters may be kept consistent across all experimental setups to avoid introducing variability that may skew the modeling results.

At block 425, the computing device executes the planned experiments under controlled conditions, and records data related to the machining parameters and corresponding performance metrics for each experiment.

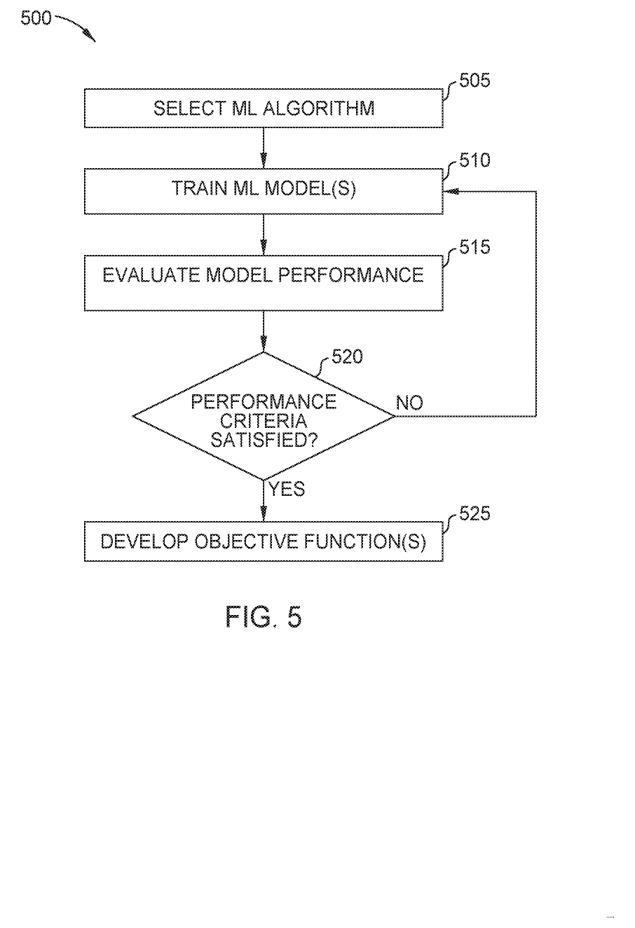

At block 430, the computing device prepares the collected data (e.g., 115 of FIG. 1A) for ML learning. In some aspects, the preparation process may include cleaning the data to remove any inconsistencies, outliers, or errors, normalizing the data to ensure all parameters are on a comparable scale, and storing the data in a structured format (e.g., database, spreadsheet) for easy access and analysis. In some aspects, the collected data may be split into training and validation datasets. With the split, the models may to be trained on one set of data (e.g., the training dataset) and validated on an independent set to evaluate their performance (e.g., the validation dataset). The prepared data may then be used to train ML models that predict performance metrics using the selected machining parameters and input features. More detail is discussed below with reference to FIG. 5.

FIG. 5 depicts an example method 500 for training ML models using collected data and developing objective functions for optimization, according to some aspects of the present disclosure. In some aspects, the method 500 may be performed by one or more computing devices, such as the computing device 800 as depicted in FIG. 8.

The method 500 begins at block 505, where a computing device selects a machining learning algorithm for training predictive models. The selection of algorithms may depend on the nature of the data and the specific performance metrics of interest. In CNC machining, performance metrics typically yield continuous outputs (e.g., cutting time, tool wear, or power consumption). Therefore, algorithms for regression models may be selected, which include, but are not limited to, linear regression, random forest regression, SVM, and ANN.

At block 510, the computing device trains models using the selected algorithm and the collected data (at block 430 of FIG. 4). The models may be designed to predict performance metrics from machining parameters. In some aspects, for each performance metric (identified at block 405 of FIG. 4), a respective predictive model may be developed. During training, the selected machining parameters (e.g., cutting speed, feed rate, depth of cut) may be used as input features, and the specific performance metrics (e.g., cutting time, tool life) may be set as target outputs. The computing device may adjust the model’s internal parameters (e.g., weights in neural networks) to minimize the errors between the predicted outputs and target outputs.

At block 515, the computing device evaluates the accuracy of the trained models and, based on the evaluation, fine-tunes the models as necessary to avoid overfitting and improve performance. In some aspects, the models may be trained using a set of data (e.g., the training dataset), and validated using a separate data set (e.g., the validation dataset).

At block 520, the computing device determines whether the models meet one or more predefined performance criteria before deployment. The performance criteria may be defined using metrics like accuracy, MSE, R-squared, and the like. If the models meet the performance criteria, the method 500 proceeds to block 525. If the models fail to meet any of these criteria, the method 500 returns to block 510, where the models may be adjusted to further improve their performance.

At block 525, the computing device uses the trained models to predict performance metrics (e.g., cutting time, tool life) based on the input parameters. The device then defines the objective functions based on these predictions. For example, the objective function for minimizing cutting time may be defined as minimize y₁^ = minimize (f₁(x)). The objective functions for maximizing total tool life may be defined as minimizing total negative tool life, represented as minimize (-y₂^) = minimize (-f₂(x)).

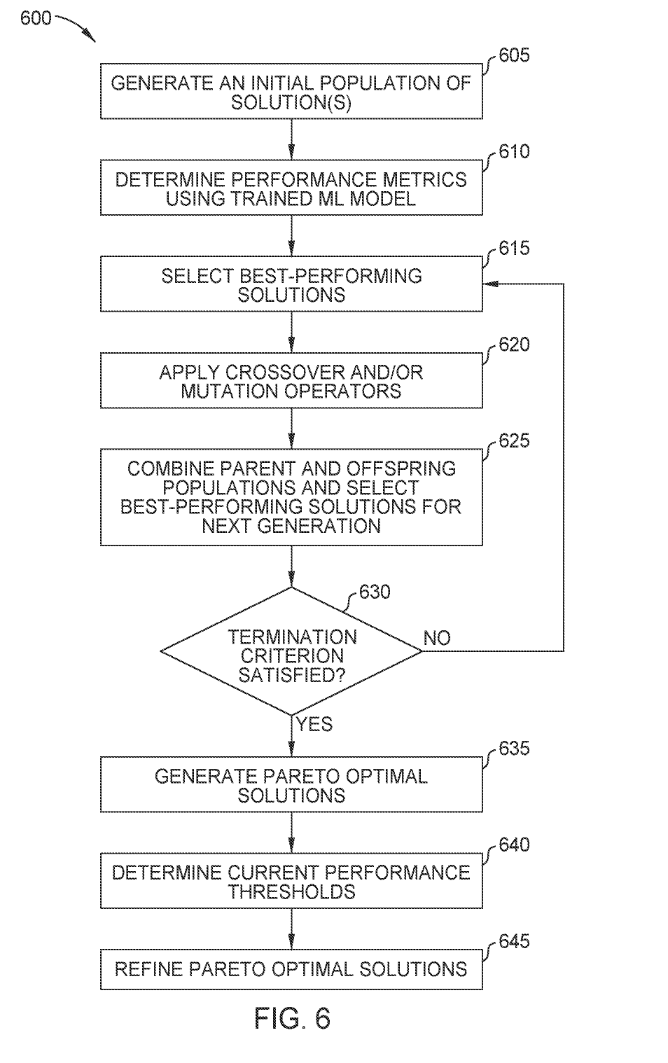

FIG. 6 depicts an example method 600 for generating and refining pareto optimal solutions using many-objective optimization algorithms, according to some aspects of the present disclosure. In some aspects, the method 600 may be performed by one or more computing devices configured with many-objective optimization algorithms, such as the computing device 800 as depicted in FIG. 8. As used herein, the many-objective optimization algorithm may refer to computational techniques designed to handle optimization problems involving multiple conflicting objectives. Examples of such algorithms include NSGA-III or MOEA/D.

At block 605, a computing device applies a many-objective optimization algorithm to generate an initial population of solutions. Each solution is characterized by a set of machining parameters, such as cutting speed, feed rate, and depth of cut. In some aspects, the initial population of solutions may be generated randomly. In some aspects, the solutions may be generated based on heuristic or domain-specific knowledge that suggests certain parameter ranges tend to yield better performance.

At block 610, for each solution in the initial population, the computing device utilizes previously trained ML models to predict corresponding performance metrics (e.g., cutting time, total tool life).

At block 615, the computing device applies the many-objective algorithm to select the best-performing solutions from the initial population. In some aspects, the selection process may involve techniques like tournament selection, roulette selection, or rank-based selection, which are designed to maintain genetic diversity within the population while focusing on the best-performing individual solutions.

At block 620, the computing device applies genetic operators, like crossover operators or mutation operators, to the selected solutions to create new candidates. In some aspects, the computing device may apply crossover operators to combine pairs of parent solutions (e.g., the solutions selected at block 615) to generate offspring solutions. After combination, mutation operators may be applied to introduce small random changes to offspring solutions to maintain diversity in the population. For each offspring solution, trained ML models may be used to predict corresponding performance metrics (e.g., cutting time, total tool life).

At block 625, the computing device combines the parent and offspring populations, and applies the many-objective algorithms to select the best-performing solutions from the combined population to form the next generation. In some aspects, techniques such as non-dominated sorting or crowding distance may be used to determine the best-performing solutions within the combined population.

At block 630, the computing device evaluates whether a predefined termination criterion for the many-objective optimization process has been met. In some aspects, the termination criterion may include a predefined maximum number of generations, and the termination criterion is met when the maximum number of generations has been reached. In some aspects, the termination criterion may refer to the convergence of solutions, where changes in solution quality (e.g., improvements in objective function values) become negligible over successive generations. If the termination criterion is met, the method 600 proceeds to block 635. If the termination criterion is not met, the method 600 returns to block 615, where the computing device applies the many-objective algorithm to reproduce additional solutions (e.g., using genetic operators like crossover and mutation), and select the best-performing solutions for the next generation.

At block 635, the computing device identifies the pareto front from the final population, where the pareto front includes a set of pareto optimal solutions (e.g., 135 of FIG. 1B). In some aspects, each solution may be characterized by a set of machining parameters (e.g., cutting speed, feed rate, and depth of cut), and provide a tradeoff among multiple objectives (e.g., minimizing cutting time, maximizing tool life).

At block 640, the computing device determines the current performance thresholds (e.g., 145 of FIG. 1B) that serve as baselines for further refining the generated pareto optimal solutions. In some aspects, to determine the current performance thresholds (e.g., threshold cutting time, threshold total tool life), the computing device may first measure the CNC machine’s current operating parameters, which may include cutting speed, feed rate, depth of cut, part hardness, cutting angle, and tool nose radius. With the current machining/operating parameters as inputs, the computing device may then use previously trained ML models to predict performance metrics. These metrics may include cutting time, total tool life, cutting tool wear, material removal rate, surface roughness, and power consumption. The predicted performance metrics represent the machine’s performance under existing conditions, and may be used as baselines to evaluate the potential improvements offered by the pareto optimal solutions.

At block 645, the computing device compares each pareto optimal solution against the current performance thresholds (e.g., 145 of FIG. 1B), and excludes solutions that do not meet or exceed the current thresholds. The refined set of pareto optimal solutions (e.g., 150 of FIG. 1B) represents the options that provide improvements over the current performance.

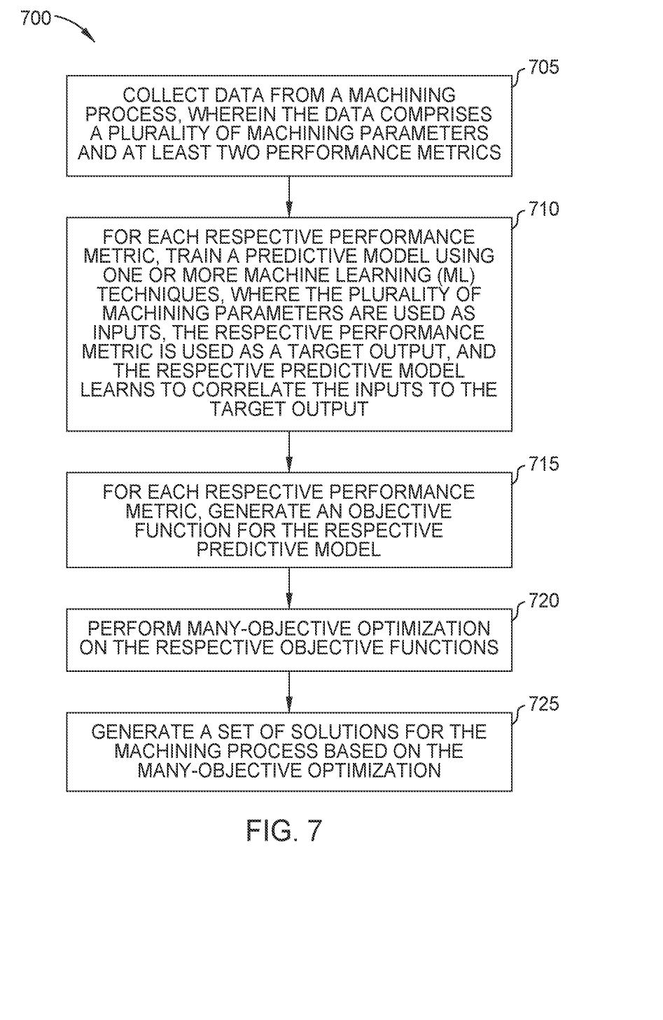

FIG. 7 is a flow diagram depicting an example method 700 for machine learning-based many-objective optimization, according to some aspects of the present disclosure.

At block 705, a computing device collects data from a machining process, where the data comprises a plurality of machining parameters (e.g., 105 of FIG. 1A) and at least two performance metrics (e.g., 110 of FIG. 1A).

At block 710, for each respective performance metric, the computing device trains a respective predictive model using one or more machine learning (ML) techniques, where the plurality of machining parameters are used as inputs, the respective performance metric is used as a target output, and the respective predictive model learns to correlate the inputs to the target output.

At block 715, for each respective performance metric, the computing device generates a respective objective function (e.g., 125 of FIG. 1A) for the respective predictive model.

At block 720, the computing device performs many-objective optimization on the respective objective functions.

At block 725, the computing device generates a set of solutions (e.g., 135 of FIG. 1B) for the machining process based on the many-objective optimization.

In some aspects, each solution may represent a trade-off between the objective functions, and each solution may comprise a combination of values for the plurality of machining parameters.

In some aspects, the machining process may comprise manufacturing an aircraft component.

In some aspects, the plurality of machining parameters may comprise at least one of cutting speed, feed rate, depth of cut, part hardness, tool tip angle, cutting angle, and tool nose radius.

In some aspects, the performance metrics may comprise at least two of tool life, cutting time, cutting force, cutting tool wear, material removal rate, surface finish quality, and power consumption.

In some aspects, subsequent to generating the set of solutions, the computing device may evaluate the machining process to determine current thresholds (e.g., 145 of FIG. 1B) for the at least two performance metrics, and filter the set of solutions based on the current thresholds, where a solution not meeting the current thresholds is excluded.

In some aspects, for each respective performance metric, the computing device may validate the respective predictive model using a separate validation dataset, and generate the respective objective function for the respective predictive model upon determining an accuracy of the respective predictive model exceeds a defined threshold.

FIG. 8 depicts an example computing device 800 configured to perform various aspects of the present disclosure, according to some aspects of the present disclosure. Although depicted as a physical device, in some aspects, the computing device 800 may be implemented using virtual device(s), and/or across a number of devices (e.g., in a cloud environment).

As illustrated, the computing device 800 includes a CPU 805, memory 810, storage 815, one or more network interfaces 825, and one or more I/O interfaces 820. In the illustrated aspect, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally considered to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated aspect, the memory 810 includes a data collection component 850, a model training component 855, a many-objective optimization component 860, and a performance evaluation component 865. Although depicted as discrete components for conceptual clarity, in some aspects, the operations of the depicted components (and others not illustrated) may be combined or distributed across any number of components. Further, although depicted as software residing in memory 810, in some aspects, the operations of the depicted components (and others not illustrated) may be implemented using hardware, software, or a combination of hardware and software.

In some aspects, the data collection component 850 may be configured to collect data (e.g., 115 of FIG. 1A) from CNC machines and potentially other relevant sources. The component 850 may focus on gathering data for selected machining parameters (e.g., cutting speed, feed rate, and depth of cut) and performance metrics (e.g., cutting time, total tool life). After collection, the data collection component 850 may preprocess the data to make it ready for model training. In some aspects, the component 850 may clean the data to remove any inconsistencies, outliers, and/or errors, normalize the data to ensure all parameters are on a comparable scale, and store the data in a structured format (e.g., database, spreadsheet) for easy access and analysis.

In some aspects, the model training component 855 may develop and train ML models using the collected data (e.g., 115 of FIG. 1A). The component 855 may include capabilities to handle various types of ML algorithms, such as linear regression, random forest regression, SVM, and ANN. The predictive models, once deployed, may be used to predict performance metrics (e.g., cutting time, tool life) based on the input parameters (e.g., cutting speed, feed rate, and depth of cut). In some aspects, the component 855 may define objective functions for each model (e.g., 125 of FIG. 1A), and provide these functions to the many-objective optimization component 860 for further processing.

In some aspects, the many-objective optimization component 860 may implement the many-objective evolutionary algorithms, such as NSGA-III or MOEA/D, and utilize the results from the ML models to find optimal (or near-optimal) solutions across multiple considered objectives. The component 860 may identify tradeoffs between one or more competing objectives (e.g., minimizing cutting time, maximizing tool life), and generate a set of pareto optimal solutions (e.g., 135 of FIG. 1B) that balance these objectives.

In some aspects, the performance evaluation component 865 may evaluate the generated pareto optimal solutions (e.g., 135 of FIG. 1B) against current performance thresholds (e.g., 145 of FIG. 1B), and identify solutions (e.g., 150 of FIG. 1B) that provide an improvement over the current machine settings.

In the illustrated example, the storage 815 may include a variety of data for effective operation and management of the machining optimization system, including, but not limited to, data collected from machining operations 875 (e.g., data collected for selected machining parameters and/or performance metrics), trained ML models 880 (e.g., the model’s parameters, weights and structure), pareto front data 885 (e.g., the set of pareto optimal solutions identified by many-objective optimization algorithms), and threshold data 890 (e.g., threshold cutting time, threshold total tool life). In some aspects, the aforementioned data may be saved in a remote database that connects to the computing device 800 via a network (e.g., the Internet).

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
collecting data from a machining process, wherein the data comprises a plurality of machining parameters and at least two performance metrics;
for each respective performance metric:
training a respective predictive model using one or more machine learning (ML) techniques, wherein the plurality of machining parameters are used as inputs, the respective performance metric is used as a target output, and the respective predictive model learns to correlate the inputs to the target output; and
generating a respective objective function for the respective predictive model;
performing many-objective optimization on the respective objective functions; and
generating a set of solutions for the machining process based on the many-objective optimization.

2. The method of claim 1, wherein each solution represents a trade-off between the objective functions, and wherein each solution comprises a combination of values for the plurality of machining parameters.

3. The method of claim 1, wherein the machining process comprises manufacturing an aircraft component.

4. The method of claim 3, wherein the plurality of machining parameters comprise at least one of cutting speed, feed rate, depth of cut, part hardness, tool tip angle, cutting angle, and tool nose radius.

5. The method of claim 3, wherein the performance metrics comprise at least two of tool life, cutting time, cutting force, cutting tool wear, material removal rate, surface finish quality, and power consumption.

6. The method of claim 1, further comprising:
subsequent to generating the set of solutions, evaluating the machining process to determine current thresholds for the at least two performance metrics; and
filtering the set of solutions based on the current thresholds, wherein a solution not meeting the current thresholds is excluded.

7. The method of claim 1, further comprising:
for each respective performance metric:
validating the respective predictive model using a separate validation dataset; and
generating the respective objective function for the respective predictive model upon determining an accuracy of the respective predictive model exceeds a defined threshold.

8. A system comprising:
one or more computer processors; and
one or more memories collectively containing one or more programs, which, when executed by the one or more computer processors, perform operations, the operations comprising:
collecting data from a machining process, wherein the data comprises a plurality of machining parameters and at least two performance metrics;
for each respective performance metric:
training a respective predictive model using one or more machine learning (ML) techniques, wherein the plurality of machining parameters are used as inputs, the respective performance metric is used as a target output, and the respective predictive model learns to correlate the inputs to the target output; and
generating a respective objective function for the respective predictive model;
performing many-objective optimization on the respective objective functions; and
generating a set of solutions for the machining process based on the many-objective optimization.

9. The system of claim 8, wherein each solution represents a trade-off between the objective functions, and wherein each solution comprises a combination of values for the plurality of machining parameters.

10. The system of claim 8, wherein the machining process comprises manufacturing an aircraft component.

11. The system of claim 10, wherein the plurality of machining parameters comprise at least one of cutting speed, feed rate, depth of cut, part hardness, tool tip angle, cutting angle, and tool nose radius.

12. The system of claim 10, wherein the performance metrics comprise at least two of tool life, cutting time, cutting force, cutting tool wear, material removal rate, surface finish quality, and power consumption.

13. The system of claim 8, wherein the one or more programs, which, when executed on any combination of the one or more computer processors, perform the operations further comprising:
subsequent to generating the set of solutions, evaluating the machining process to determine current thresholds for the at least two performance metrics; and
filtering the set of solutions based on the current thresholds, wherein a solution not meeting the current thresholds is excluded.

14. The system of claim 8, wherein the one or more programs, which, when executed on any combination of the one or more computer processors, perform the operations further comprising:
for each respective performance metric:
validating the respective predictive model using a separate validation dataset; and
generating the respective objective function for the respective predictive model upon determining an accuracy of the respective predictive model exceeds a defined threshold.

15. One or more non-transitory computer-readable media containing, in any combination, computer program code that, when executed by operation of a computer system, performs operations comprising:
collecting data from a machining process, wherein the data comprises a plurality of machining parameters and at least two performance metrics;
for each respective performance metric:
training a respective predictive model using one or more machine learning (ML) techniques, wherein the plurality of machining parameters are used as inputs, the respective performance metric is used as target outputs, and the respective predictive model learns to correlate the inputs to the target output; and
generating a respective objective function for the respective predictive model;
performing many-objective optimization on the respective objective functions; and
generating a set of solutions for the machining process based on the many-objective optimization.

16. The one or more non-transitory computer-readable media of claim 15, wherein each solution represents a trade-off between the objective functions, and wherein each solution comprises a combination of values for the plurality of machining parameters.

17. The one or more non-transitory computer-readable media of claim 15, wherein the machining process comprises manufacturing an aircraft component, and wherein the plurality of machining parameters comprise at least one of cutting speed, feed rate, depth of cut, part hardness, tool tip angle, cutting angle, and tool nose radius.

18. The one or more non-transitory computer-readable media of claim 17, wherein the performance metrics comprise at least two of tool life, cutting time, cutting force, cutting tool wear, material removal rate, surface finish quality, and power consumption.

19. The one or more non-transitory computer-readable media of claim 15, wherein the computer program code that, when executed by operation of the computer system, performs operations further comprising:
subsequent to generating the set of solutions, evaluating the machining process to determine current thresholds for the at least two performance metrics; and
filtering the set of solutions based on the current thresholds, wherein a solution not meeting the current thresholds is excluded.

20. The one or more non-transitory computer-readable media of claim 15, wherein the computer program code that, when executed by operation of the computer system, performs operations further comprising:
for each respective performance metric:
validating the respective predictive model using a separate validation dataset; and
generating the respective objective function for the respective predictive model upon determining an accuracy of the respective predictive model exceeds a defined threshold.
